(19) United States
(12) Patent Application Publication
(10) Pub. No.: US 2007/0106605 A1
(43) Pub. Date: May 10, 2007

(54) Apparatus and method for determining billable resources on a computer network

(75) Inventors: Steven David Kaplan, Peoria, AZ (US); Mark Alvir Weiman, Loveland, CO (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 11/259,316

(22) Filed: Oct. 26, 2005

(51) Int. Cl. G06Q 40/00

(52) U.S. Cl. 705/40

(57) ABSTRACT

An apparatus and method for determining billable resources on a computer network determines from network activity data which resources on a computer network are active. The activity monitor then compares the active resources to asset data that indicates the resources being billed to the client. If the active resources on the network do not match the resources being billed to the client, the discrepancy is reported. In this manner, billing records may be updated to reflect billing for resources that are active, thereby enhancing the accuracy of the billing for the resources. This greatly reduces the potential for a client cheating by using resources without paying, thereby enhancing the revenue of the provider of the computer resources. This also reduces the potential for a provider to erroneously bill a client for resources that are not being used.

### BACKGROUND OF THE INVENTION

1. Technical Field

This invention generally relates to computer systems, and more specifically relates to billing of resources on networked computer systems.

2. Background Art

Many computer companies bill their clients according to the client's usage of computer resources on a network. Many different billing practices have evolved over the years. Some computer companies bill monthly a set rate for each resource used by the client. Some bill according to how much a resource is used. For example, a computer company that provides and maintains a large database can charge a client according to how many records are inserted into the database. There are many different metrics and heuristics for billing clients for computer resources. Virtually all of these depend on an accurate accounting of resources being used by a client.

In a very large computer network with hundreds or thousands of resources, the tracking of billable resources becomes very problematic. New resources may be added to the network, and old resources may be taken off the network. Verifying that the client is billed for the right number of resources is no small task. Typically, the computer company maintains a database of resources, or assets, that should be billed to the client. However, people sometimes make mistakes in data entry, which results in inaccuracies in the asset database. Software agents may not accurately report resources that are being used. In addition, clever clients may find ways to use resources without paying for them. Without a way to accurately determine billable resources used on a computer network, the computer industry will continue to suffer from inefficient and error-prone methods of billing clients for resources on a computer network.

### DISCLOSURE OF INVENTION

According to the preferred embodiments, an apparatus and method for determining billable resources on a computer network determines from network activity data which resources on a computer network are active. The activity monitor then compares the active resources to asset data that indicates the resources being billed to the client. If the active resources on the network do not match the resources being billed to the client, the discrepancy is reported. In this manner, billing records may be updated to reflect billing for resources that are active, thereby enhancing the accuracy of the billing for the resources. This greatly reduces the potential for a client cheating by using resources without paying, thereby enhancing the revenue of the provider of the computer resources. This also reduces the potential for a provider to erroneously bill a client for resources that are not being used.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a block diagram of a prior art computer network;

FIG. 3 is a block diagram of a computer network in accordance with the preferred embodiments; and

FIG. 4 is a method for determining billable resources on a computer network in accordance with the preferred embodiments.

### BEST MODE FOR CARRYING OUT THE INVENTION

The preferred embodiments provide a way to monitor which resources on a computer network are actually active, and to compare the active resources with asset data that indicates which resources are currently being billed to the client. If there are active resources that are not being billed, the provider of the resources can correct the billing records to charge the client for all the active resources. In this manner, the accuracy of billing the resources is greatly improved.

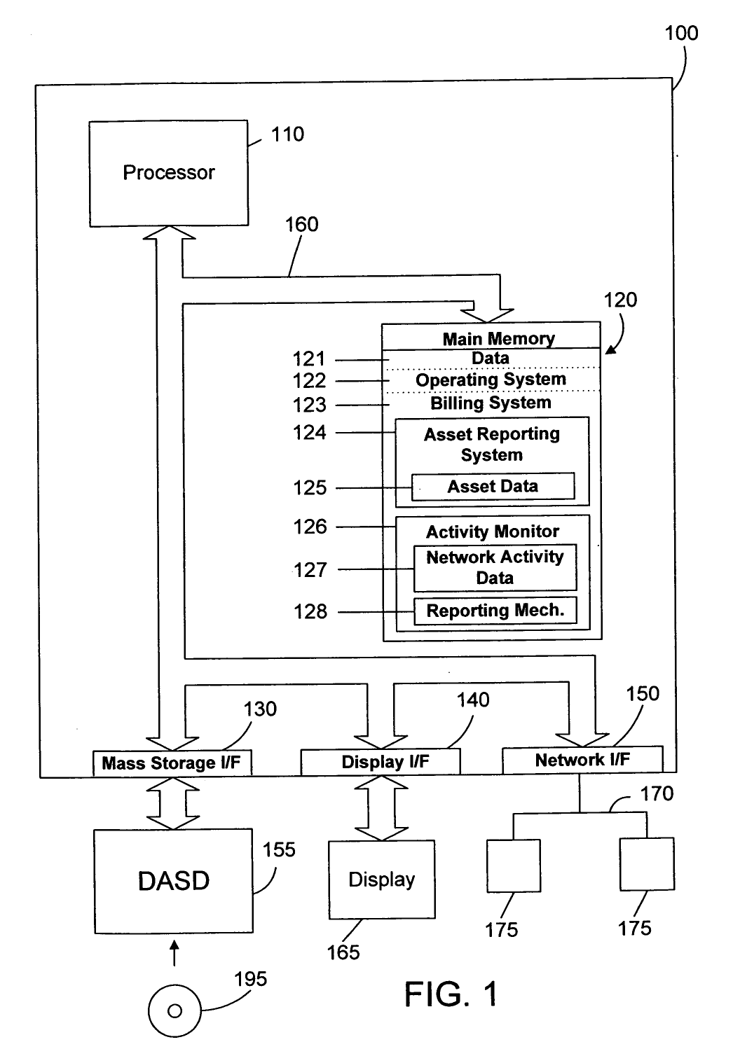

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, and a billing system 123. Data 121 represents any data that serves as input to or output from any program in computer system 100. Operating system 122 is a multitasking operating system known in the industry as i5/OS; however, those skilled in the art will appreciate that the spirit and scope of the present invention is not limited to any one operating system. Billing system 123 is a software package that is responsible for tracking which resources are used on a network so the client can be billed its use of the resources. The billing system 123 includes an asset reporting system 124 and an activity monitor 126. The asset reporting system 124 includes asset data 125 that indicates which assets (or resources) on the network should be billed to the client. The asset data 125 typically resides in an asset database.

The activity monitor 126 receives network activity data 127 that indicates which resources on the computer network are active. The activity monitor 126 then compares the active resources to the resources currently being billed in the asset database. If there is a discrepancy, the discrepancy is reported by the reporting mechanism 128. For example, the reporting mechanism 128 may send a message to a system administrator that indicates that a manual update of the asset data 125 needs to be performed. In the alternative, the reporting mechanism 128 could autonomically make changes to the asset data 125, and may send an optional message to a system administrator indicating the changes made to the asset data 125, thereby allowing the system administrator to verify the changes. The billing system 123 of the preferred embodiments provides significantly greater accuracy in determining billable resources on a computer network by comparing resources that are active on the network to the resources currently being billed according to the asset data. Note that the billing system 123 prevents both overcharges and undercharges for resources. If the client is attempting to cheat by using resources that are not currently being billed, these resources will be detected as active, allowing the provider of the resources to correct the undercharges and to bill for all of the active resources. If the client is being billed for resources that are no longer in use, these resources will be detected as inactive, allowing the provider of the resources to correct the overcharges and to bill for only the active resources. The preferred embodiments allow billing for only those resources that are active on a computer network.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, and billing system 123 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links. Note that the preferred signal bearing media is tangible.

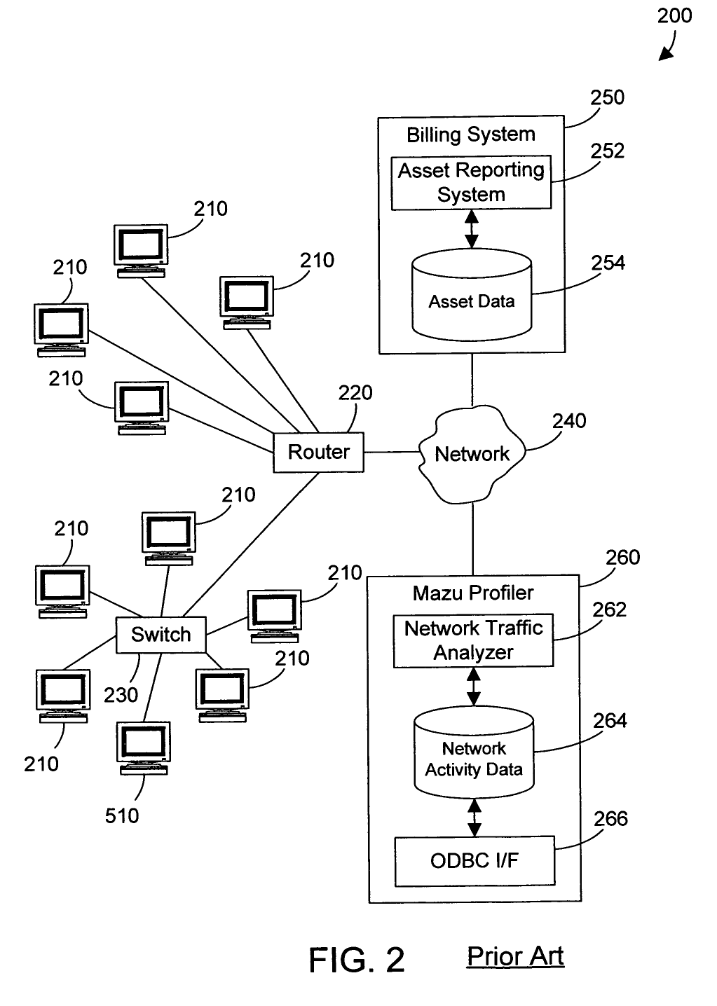

Two specific examples are now presented to compare and contrast the prior art to the present invention. A prior art networked computer system 200 is shown in FIG. 2. The networked computer system 200 includes multiple resources 210 on a computer network. The resources 210 shown in FIG. 2 are shown as computer systems, however, the term “resource” used herein denotes any resource on the computer system that could be billed to a client, including processor capacity, memory, hard disks, databases, etc. Several resources 210 are shown coupled to a router 220, and several other resources 210 are shown coupled to a switch 230 that is coupled to the router 220. The router 220 is coupled to a network 240. The specific network topology for connecting the resources to the network in unimportant. The preferred embodiments expressly extend to any and all connection types and topologies for networked resources. In the sample networked computer system 200 shown in FIG. 2, a billing system 250 is coupled to the network 240. Note that billing system 250 represents software that may execute on any computer system coupled to the network 240. The billing system 250 includes an asset reporting system 252 that maintains a database of asset data 254. The asset data 254 includes a list of resources that should be billed to a client.

One problem with the prior art billing system 250 is it relies upon humans or software agents for its accuracy. Humans typically insert and delete items into the asset database. If data is entered incorrectly, or if someone forgets to make some needed updates, the asset data 254 will not accurately reflect the resources the client is currently using. Software agents can be faulty, may not interact safely with other application on a computer system and thus become non-functional, or may not be able to report due to network design problems or other potential problems. The result is that tracking assets that should be billed to a client is not a simple problem to solve.

In very large networks that include thousands of resources, the tracking of asset data 254 becomes very difficult, and it is hard to say with confidence at any given time that the asset data 254 accurately reflects the resources being used by the client. The bills sent to the client are based on the asset data 254, and thus can only be as accurate as the asset data 254. If the asset data 254 understates the resources used by the client, the provider will charge the client too little. If the asset data 254 overstates the resources used by the client, the provider will charge the client too much. The billing system 250 essentially relies upon the accuracy of the asset data 254, which may be subject to errors.

The prior art computer system 200 also includes a Mazu profiler 260, which is software that runs on a computer system coupled to the network 240. The Mazu Profiler 260 is a product available from Mazu Networks, 125 Cambridge Park Drive, Cambridge, Mass. 02140. The Mazu Profiler 260 is a tool that analyzes network traffic and behavior, and provides the tools required to detect and mitigate security and operational threats, isolate risky activity, and respond quickly to a crises without disruption of normal business operations. The Mazu Profiler 260 is a network security tool that is primary designed to stop worms and insider threats without stopping normal business operations. The Mazu Profiler 160 includes a network traffic analyzer 262 that collects network traffic information all over the network. The network traffic analyzer 262 may collect network traffic information from routers such as 220, from switches such as 230, from third party probes, and from proprietary sensors provided by Mazu Networks. The network traffic analyzer 262 analyzes the network traffic, and generates therefrom network activity data 264 that indicates the network traffic in the network. The network activity data may then be used by the Mazu Profiler to stop worms and insider attacks by detecting differences between normal network communications and abnormal network communications that result from the activity of the worm or insider activity. Note that the Mazu Profiler 260 includes an Open Database Connectivity (ODBC) interface 266 that allows accessing object oriented objects in the Mazu Profiler 260, including the objects that contain network activity data 264. This ODBC interface 266 may be used, for example, but various tools that analyze the network activity data 264 after an insider attack has been mitigated to perform post-processing to track down how the attack happened.

In prior art system 200, the function and purpose of the billing system 250 is completely different and unrelated to the function and purpose of the Mazu Profiler 260. These two software packages operate independently of one another. The billing system 250 bills clients for resources used on the computer network. The Mazu Profiler 160 analyzes network traffic to prevent worms and insider attacks.

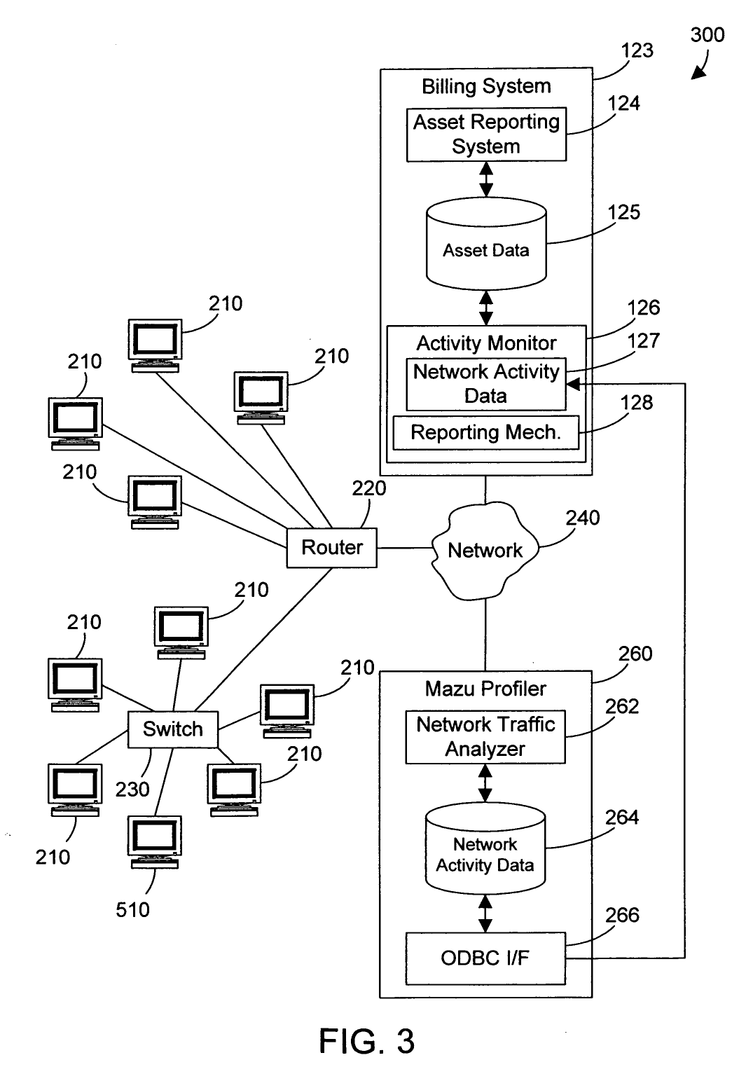

The present invention is based on the realization that network activity data gathered by the Mazu Profiler is an indication of active resources on the network. In the preferred embodiments, the billing system reads the network activity data to determine which resources on the network are active, compares the active resources on the network with the billed resources indicated by the asset data, and reports any discrepancies between the active resources and the billed resources. Referring to FIG. 3, a networked computer system 300 in accordance with the preferred embodiments includes the billing system 123 shown in FIG. 1 with its various components 124-128. System 300 also includes the same Mazu Profiler 260 shown in the prior art system in FIG. 2. The network activity data 127 in the billing system 123 is read from the network activity data 264 in the Mazu Profiler 260 via the ODBC interface 266. The activity monitor 126 processes the network activity data 127 to determine which resources on the network are active. Note that what constitutes an “active” resource may be defined in any suitable way using any suitable heuristic or criteria. For example, a threshold number of network messages over a given period of time could be defined. If a resource has a number of network messages over the given time period that is equal to or exceeds the threshold, the activity monitor 126 determines that the resource is active. If the resource has a number of network messages over the given time period that is less than the threshold, the activity monitor 126 determines that the resource is inactive. Of course, this is a very simple example, and the preferred embodiments extend to any suitable heuristic or criteria for determining when a resource is active and inactive.

The activity monitor 126 thus processes the network activity data 127 in accordance with one or more criteria for determining whether the resource is active or not, and generates a list of active resources. The activity monitor 126 then reads the asset data 125 to determine the billed resources on the network. The active resources are then compared to the billed resources. If there are any discrepancies between the active resources and the billed resources, the activity monitor 126 uses its reporting mechanism 128 to report the discrepancies. In one embodiment, the reporting mechanism 128 reports the discrepancies to a system administrator via a message. In another embodiment, the reporting mechanism 128 signals the billing system 123 of the discrepancy, which then autonomically corrects the asset data 125 to match the active resources. This autonomic correction of the asset data 125 is preferably accompanied by a message to a system administrator so the system administrator can verify the autonomic correction to the asset data 125.

The dynamic monitoring and possible autonomic adjustment greatly simplifies the billing system of the preferred embodiments. For example, a provide may sell twenty new workstations to a client that will be placed on the client's network. In the prior art, a date is typically selected that is the date the client begins getting billed for the workstations. Selecting a common date for all twenty workstations does not account for potential problems with the installation of the workstations, or for the time to install the workstations one-at-a-time on the network, which may span several days. The preferred embodiments solve this problem by determining from the network activity data when a workstation becomes active on the network, and autonomically beginning the billing for that workstation. In similar fashion, resources may be removed from the network, and the billing system 123 can detect when resources become inactive, and can therefore halt billing for those resources. The result is a billing system that only bills a client for the resources that are active on the network. Of course, the functionality of the billing system depends on the billing policies of the provider. For example, a provider may specify that a workstation is to be billed at a monthly rate for a minimum of twelve months. If the workstation is taken off the network after ten months, the billing system will still bill for the inactive system due to the billing policy of the provider. This simple illustration shows how billing policies may affect the billing of resources to a client. In other words, the fact that a resource is active doesn't necessarily mean the client should be billed for the resource. And the fact that a resource is inactive doesn't necessarily mean the billing for the resource should stop. The preferred embodiments expressly extend to using the information of which resources on the network are active and which are inactive with any suitable billing policy to determine when to bill or not bill a client.

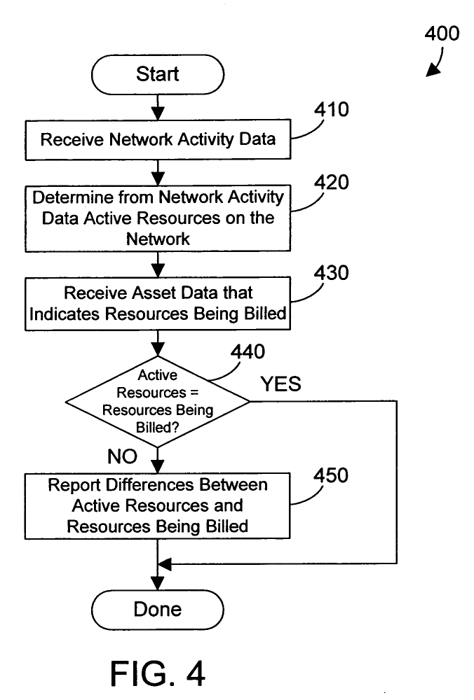

Referring to FIG. 4, a method 400 in accordance with the preferred embodiments represents steps that are preferably performed by the billing system 123 in FIGS. 1 and 3. First, network activity data is received (step 410). The network activity data is processed to determine which resources on the network are active (step 420). As explained above, what constitutes an “active” resource may be defined in any suitable way. Asset data is then received that indicates the resources being billed to the client (step 430). If the active resources match the billed resources (step 440=YES), method 400 is done, and no action needs to be taken because the active resources are the same as the billed resources. If the active resources are not the same as the billed resources (step 440=NO), the differences (or discrepancies) between the active resources and the billed resources are reported (step 450). As stated above, the differences may be reported to a system administrator, or may be used to autonomically adjust the asset data. In this manner, the actual activity of resources on a network is determined and compared to the resources being billed, thereby allowing adjustments to make the two match.

The preferred embodiments greatly enhance the accuracy of a billing system by using network activity data to determine which resources on a network are active. The active resources are compared to the billed resources, and any discrepancies between the two are reported. In this manner, the billing system assures greater accuracy in billing a client for the resources the client is actively using.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor; and
a billing system residing in the memory and executed by the at least one processor, the billing system receiving network activity data, determining from the network activity data which of a plurality of resources on a computer network are active, comparing the active resources to asset data that indicates billed resources on the computer network, and reporting any discrepancy between the active resources and the billed resources.

2. The apparatus of claim 1 wherein the network activity data is received by the billing system from a different computer system coupled to the computer network that monitors network activity.

3. The apparatus of claim 1 wherein the billing system reports any discrepancy by sending a message to a system administrator.

4. The apparatus of claim 1 wherein the billing system reports any discrepancy by autonomically correcting the asset data.

5. The apparatus of claim 1 wherein the active resources and billed resources comprise a plurality of computer systems.

6. The apparatus of claim 1 wherein the billing system determines from the network activity data which of the plurality of resources on the computer network are active according to at least one predefined activity criterion.

7. A networked computer system comprising:
a computer network coupled to a plurality of resources;
a first computer system coupled to the computer network that monitors activity on the computer network and generates therefrom network activity data for the plurality of resources; and
a second computer system coupled to the computer network that includes a billing system that receives the network activity data from the first computer system, determines from the network activity data which of the plurality of resources on the computer network are active, compares the active resources to asset data that indicates billed resources on the computer network, and reports any discrepancy between the active resources and the billed resources.

8. The apparatus of claim 7 wherein the billing system reports any discrepancy by sending a message to a system administrator.

9. The apparatus of claim 7 wherein the billing system reports any discrepancy by autonomically correcting the asset data.

10. The apparatus of claim 7 wherein the active resources and billed resources comprise a plurality of computer systems.

11. The apparatus of claim 7 wherein the billing system determines from the network activity data which of the plurality of resources on the computer network are active according to at least one predefined activity criterion.

12. A computer-implemented method for determining billable resources on a computer network, the method comprising the steps of:
determining which resources on the computer network are active;
comparing the active resources to asset data that indicates billed resources on the computer network; and
reporting any discrepancy between the active resources and the billed resources.

13. The method of claim 12 wherein the step of reporting any discrepancy comprises the step of sending a message to a system administrator.

14. The method of claim 12 further comprising the step of autonomically correcting the asset data based on any reported discrepancy between the active resources and the billed resources.

15. The method of claim 12 wherein the active resources and billed resources comprise a plurality of computer systems.

16. The method of claim 12 wherein the billing system determines from the network activity data which of the plurality of resources on the computer network are active according to at least one predefined activity criterion.

17. A program product comprising:
(A) a billing system that receives network activity data, determines from the network activity data which of a plurality of resources on a computer network are active, compares the active resources to asset data that indicates billed resources on the computer network, and reports any discrepancy between the active resources and the billed resources; and
(B) computer-readable signal bearing media bearing the billing system.

18. The program product of claim 17 wherein the computer-readable signal bearing media comprises recordable media.

19. The program product of claim 17 wherein the computer-readable signal bearing media comprises transmission media.

20. The program product of claim 17 wherein the billing system reports any discrepancy by sending a message to a system administrator.

21. The program product of claim 17 wherein the billing system reports any discrepancy by autonomically correcting the asset data.

22. The program product of claim 17 wherein the active resources and billed resources comprise a plurality of computer systems.

23. The program product of claim 17 wherein the billing system determines from the network activity data which of the plurality of resources on the computer network are active according to at least one predefined activity criterion.
